(19) United States
(12) Patent Application Publication
(10) Pub. No.: US 2010/0174785 A1
(43) Pub. Date: Jul. 8, 2010

(54) Dynamic sender blocking based on accumulated content violations

(76) Inventors: Yigang Cai, Naperville, IL (US); Suzann Hua, Lisle, IL (US)

Correspondence Address: Alcatel-Lucent;Docket Administrator, Room 2F-192, 600-700 Mountain Ave., Murray Hill, NJ, 07974-0636, US

(21) Appl. No.: 12/319,374

(22) Filed: Jan. 7, 2009

(51) Int. Cl. G06F 15/16; G06F 17/30

(52) U.S. Cl. 709/206; 709/225; 707/E17.044

(57) ABSTRACT

A content distribution gateway configured for connection between one or more content senders and at least one message center operates to dynamically block certain senders based on accumulated content violations. The content distribution gateway receives one or more electronic messages from a content sender, evaluates the messages for indicia of accumulated content violations and, responsive to the indicia exceeding a blocking criteria, blocks certain messages from the content sender. In the case where a sender is blocked based on accumulated content violations, further messages from the sender are blocked without undertaking further evaluation of content violations. The blocking feature is adaptable to accommodate different tolerances of different end users, user groups or networks.

### FIELD OF THE INVENTION

This invention relates generally to communication networks supporting messaging services and, more particularly, to a method for dynamically blocking certain senders based on accumulated content violations.

### BACKGROUND OF THE INVENTION

Many communication networks support electronic messaging services, for example, Short Message Service (SMS), Multimedia Message Service (MMS) and e-mail. A major problem with electronic messaging services is the proliferation of undesired message content and undesired message types including, without limitation, advertisements/solicitations, spam messages, weather alerts and the like, which can be distributed in virtually any messaging medium and are sometimes sent in bulk to multiple end users. A related problem is that different end users, user groups or networks can have different levels of tolerance for different content or different message types, and their tolerance levels can be influenced not only by the content or type of respective individual messages, but by the identity or characteristics of particular senders and/or the amount of content generated from those senders.

Although blocking filters exist for blocking certain messages based on message content, they are implemented ineffiently within independent message centers (e.g., Short Message Service Center (SMSC), Multimedia Message Service Center (MMSC) and email server or gateway) associated with each message medium, typically with different blocking criteria. Moreover, they operate on every instance of received message, to parse and evaluate the content of each individual message based on a static blocking criteria without consideration of different tolerances or accumulated content violations from particular senders. For example and without limitation, existing content-based blocking filters do not consider accumulated numbers and/or severity of violations from particular senders.

To improve message blocking efficiency and to improve customer satisfaction, there is a need to implement a blocking strategy based on a dynamic blocking criteria, that will accomodate different blocking criteria corresponding to different user tolerances and that will consider accumulated content violations from the senders.

### SUMMARY OF THE INVENTION

These needs are addressed and and a technical advance is achieved in the art by a feature for dynamically blocking certain senders based on accumulated content violations. The blocking feature can be implemented in a content distribution gateway or aggregator, to block messages of one or more message mediums before they reach respective message centers associated with the different message mediums; and in a manner that does not require parsing and evaluating every instance of received message. The blocking feature is adaptable to accommodate different tolerances of different end users, user groups or networks.

In one embodiment, a method for dynamically blocking certain senders comprises receiving one or more electronic messages from a sender; evaluating the messages for indices of accumulated content violations; comparing the indices to one or more blocking criteria; and responsive to the indices of accumulated content violations exceeding the blocking criteria, blocking further messages from the sender.

In another embodiment, a method for dynamically blocking certain senders comprises receiving an electronic message from a sender directed to an end user; evaluating the message for content violations; responsive to finding one or more content violations, determining indicia of accumulated content violations associated with messages from the sender directed to the end user; comparing the indicia of accumulated content violations to one or more blocking criteria associated with the end user; and if the blocking criteria is exceeded, blocking the message from delivery to the end user.

In another embodiment, there is provided an apparatus for dynamically blocking certain senders based on accumulated content violations. The apparatus comprises a gateway configured for connection between a content sender and at least one message center, the gateway comprising a processor coupled to a memory; wherein the gateway is operable under control of the processor to receive one or more electronic messages from the content sender, evaluate the messages for indicia of accumulated content violations and, responsive to the indicia exceeding a blocking criteria, blocking certain messages from the content sender.

### BRIEF DESCRIPTION OF THE DRAWINGS

The foregoing and other advantages of the invention will become apparent upon reading the following detailed description and upon reference to the drawings.

FIG. 1 is a block diagram of a communication network in an exemplary embodiment of the invention.

FIG. 2 is a flowchart of an exemplary process executable in the FIG. 1 network to dynamically block messages from certain senders based on accumulated content violations.

### DESCRIPTION OF THE PREFERRED EMBODIMENT(S)

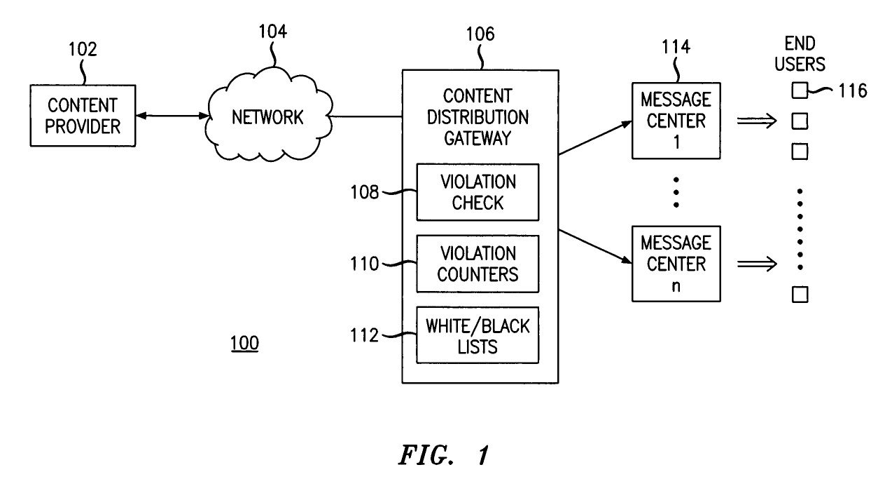

FIG. 1 illustrates a communication network 100 operable according to embodiments of the invention to support one or more electronic messaging services and to dynamically block certain senders based on accumulated content violations. Communication network 100 may represent a wireline network, an IP Multimedia Subsystem (IMS) network, a packet-based network (IP network), a wireless network, generally any type of network that is capable of supporting one or more electronic messaging modalities including, without limitation, Short Message Service (SMS), Multimedia Message Service (MMS) and e-mail.

The communication network 100 receives electronic messages from various senders 102 (one shown) comprising generally, any individuals, companies, organizations or other entities that are capable of sourcing electronic messages, via device(s), server(s) or system(s) consistent with the network topology and the messaging service modality. As is well known, the electronic messages may include content comprising, without limitation, text, symbols, images, audio or video clips, urls or the like. Typically, at least a portion of the electronic messages may include undesired content, for example and without limitation, content that is deemed annoying, offensive or possibly malicious to one or more prospective recipients. Moreover, undesired content may characterize certain types of messages including, without limitation, advertisements/solicitations, spam messages, weather alerts and the like.

The senders 102 are linked via originating network 104 to a content distribution gateway 106. The originating network 104 is a functional link that may comprise, for example and without limitation, a wireline, wireless, Internet Protocol (IP) or IP Multimedia Subsystem (IMS) network. The content distribution gateway 106 receives incoming messages via the network 104 and operates according to embodiments of the invention to distribute or dynamically block the messages from certain senders 102 based on accumulated content violations.

The content distribution gateway 106 includes a processor and memory (not shown) and is operable under control of the processor to implement a violation check function 108, violation counters 110 and blocking/filtering function 112, to evaluate various incoming messages and to determine whether to distribute or block them. As will be appreciated, the elements 108, 110, 112 are functional elements that may be implemented in one or more physical devices and may be implemented integral to or distributed from the content distribution gateway 106.

The violation check function 108 operates to parse the contents of messages under evaluation to identify the presence of various content items that are deemed annoying, offensive or possibly malicious to one or more prospective recipients, defining content violations; and to assign an error/violation code and severity code corresponding to the content violations. Alternatively or additionally, the violation check function may characterize the messages based on message type (e.g., advertisements/solicitations, spam messages, weather alerts and the like) and assign error/violation code and severity code based on message type.

In one embodiment, the violation check function 108 identifies content violations by comparing the contents of messages under review to a list of objectionable content items. For example and without limitation, the list of objectionable content items may comprise certain keywords, phrases, symbols, image types that are predetermined to be objectionable to one or more prospective recipients or that are characteristic of one or more message types that are deemed objectionable.

In one embodiment, the violation check function 108 further maintains a list of severity numbers corresponding to the objectionable content items, thereby designating based on the severity number, the degree of objectionability certain content items. For example, in one embodiment, severity number of “1” may designate items of relatively low objectionability, severity number “2” a medium objectionability and “3” a high objectionability. As will be appreciated, the severity designation can be accomplished in a variety of alternative ways.

In one embodiment, the violation check function 108 may provision different lists of objectionable content items and different severity values to accommodate different tolerances of certain end users. For example and without limitation, content items and severity values can be separately provisioned for individual end users, user groups or networks.

The violation counters 110 receive indicia of the respective senders, content violations and severity associated with individual messages from the violation check function 108 and derive indices of accumulated content violations associated with the various senders 102. In one embodiment, the indices of accumulated content violations comprise accumulated numbers of content violations and accumulated severity values associated with various senders 102; and the violation counters increment separate counters to tally the accumulated numbers of content violations and severity values associated with various senders 102. Alternatively or additionally, the violation counter may execute more sophisticated algorithms (i.e., other than simple addition) to derive indices of accumulated content violations corresponding to various senders. In embodiments where the violation check function uses different violation or severity criteria for different individual end users, user groups or networks, the violation counters maintain separate indices of accumulated content violations corresponding to the different end users, user groups or networks. In such manner, a particular sender may have different indices of accumulated content violations corresponding to different end users, user groups or networks.

The blocking/filtering function 112 receives from the violation counters, indices of accumulated content violations corresponding to various senders (and optionally, further corresponding to different end users, user groups or networks) and compares the indices to one or more blocking criteria. The blocking criteria may comprise, for example and without limitation, a maximum allowed number of accumulated content violations and/or a maximum allowed severity number associated with accumulated content violations. The blocking criteria may be stored within the content distribution gateway or may be stored externally from the content distribution gateway. The blocking criteria may differ for various senders, different end users, user groups or networks.

In one embodiment, if the indices of accumulated content violations from a particular sender exceed the blocking criteria, the blocking/filtering function blocks the current message (i.e., the message causing the accumulated content violations to exceed the blocking criteria); otherwise if the indices of accumulated content violations from a particular sender do not exceed the blocking criteria, the current message is not blocked.

In one embodiment, the blocking/filtering function maintains a database having indicia of senders that are deemed trustworthy, defining a white list. Alternatively or additionally, the the blocking/filtering function may maintain a database having indicia of senders that are deemed untrustworthy, defining a black list. Optionally, the blocking/filtering function may maintain multiple white lists or black lists corresponding to different end users, user groups or networks.

In one embodiment, upon receiving a message from a sender that is not on the white list (or alternatively, that is on the black list), the blocking/filtering function will immediately block the message without undertaking an evaluation of the contents of the message for content violations and then will return an error code or the like to the sender to inform the sender that it is blocked. In the instance that the blocking/filtering function maintains multiple white lists or black lists corresponding to different end users, user groups or networks, the message may inform the sender that it is blocked from particular end users, user groups or networks.

Optionally, a sender that is removed from the white list (or alternatively, added to a black list) may be given an opportunity to pay a penalty fee or the like to be reinstated to the white list (or removed from the black list). Optionally, the blocking/filtering function may utilize the same blocking criteria or a stricter blocking criteria after reinstatement to the white list (or removal from the black list).

Until such time that a sender is not on the white list (or alternatively, on the black list), incoming messages from the sender will be evaluated for content violations and for indices of accumulated content violations. If the indices of accumulated content violations consequent from a particular message exceed the blocking criteria, the blocking/filtering function may block the current message and remove the sender from the white list or add the sender to the black list, thereby effectively blocking further messages from the sender (at least with respect to the particular end user, user group or network to which the white or black list corresponds). In one embodiment, the blocking/filtering function further returns a message to the sender instructing the sender to deregister the end user, user group or network to which the current message was directed.

If content violations are found in a current message but the indices of accumulated content violations do not exceed the blocking criteria, or if no content violations are found in the current message, the blocking/filtering function delivers the current message to the relevant message center 114 (comprising, for example, a Short Message Service Center (SMSC), Multimedia Message Service Center (MMSC) or email server) corresponding to the message medium of the current message. The relevant message center 114 receives and processes the message for delivery to the appropriate end user(s) 116.

Optionally, the blocking/filtering function may return a warning message to the sender if content violations were found in the current message; otherwise the blocking/filtering function will deliver the current message with no warning if no content violations were found in the current message.

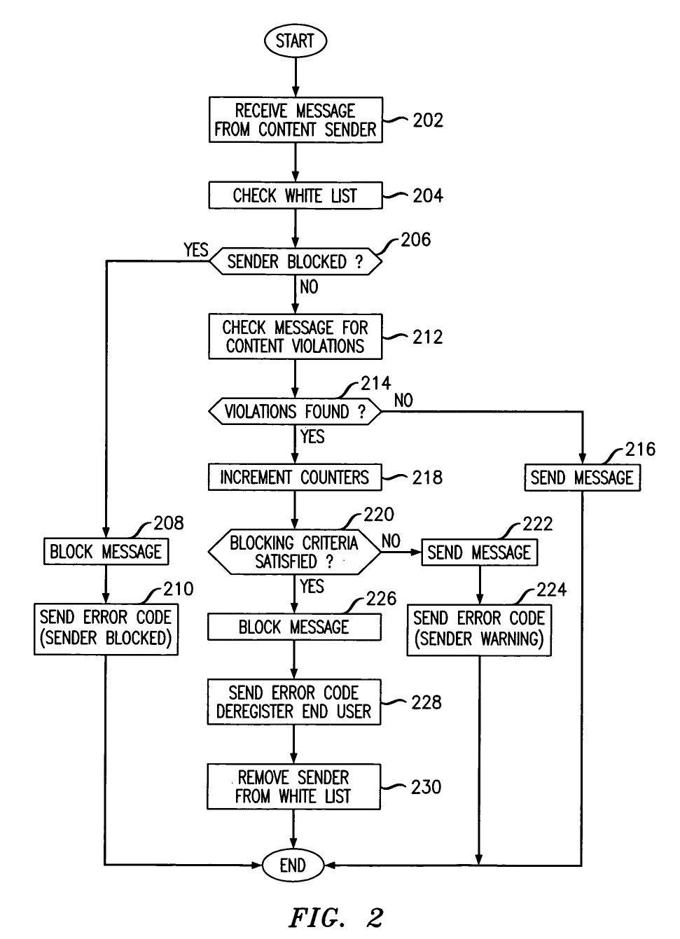

Now turning to FIG. 2, there is shown a flowchart of an exemplary process executable in the FIG. 1 network to dynamically block messages from certain senders based on accumulated content violations. In one embodiment, the steps of FIG. 2 are implemented, where applicable, by the violation check function 108, violation counters 110 and blocking/filtering function 112 of the content distribution gateway 106. For convenience, the steps of FIG. 2 will be described in relation to a single message from an individual sender directed to an individual end user. However, as will be appreciated, the steps of FIG. 2 may be executed in parallel for multiple messages from multiple senders, and in the case of a multicast or broadcast messages, a single message can be sent to multiple end users.

At step 202, the content distribution gateway 106 receives a message from a sender 102 directed to an end user 116. At step 204, the blocking/filtering function 112 of the content distribution gateway 106 checks a relevant white list (or lists) to determine whether the sender is present or absent from the white list(s). In one embodiment, presence of the sender on the white list indicates that the sender is deemed trustworthy, whereas absence of the sender from the white list indicates that the sender should be blocked. The white list may correspond to an individual end user, user group or network.

At step 206, the blocking/filtering function 112 determines if the sender is to be blocked based on its absence from the relevant white list (or lists). If the sender is to be blocked, the blocking/filtering function 112 will cause the message to be blocked at step 208, thereby stopping distribution of the message at the content distribution gateway 106 without undertaking an evaluation of the contents of the message for content violations. Blocking of the message at step 208 will further result in preventing distribution of the message to the relevant message centers 114 or end users 116.

Thereafter, at step 210, the blocking/filtering function 112 returns an error code or the like to the sender to inform the sender that it is blocked. In one embodiment, the message further instructs the sender to deregister the end user, user group or network to which the current message was directed. In the instance that the blocking/filtering function maintains multiple white lists or black lists corresponding to different end users, user groups or networks, the message may inform the sender that it is blocked from particular end users, user groups or networks, or that it is to deregister particular end users, user groups or networks.

If at step 206 it is determined that the sender is not to be blocked, for example in the case that the sender is present on the relevant white list (or lists), the violation check function 108 undertakes an evaluation of the current message for content violations at step 212. In one embodiment, at step 212 the violation check function 108 evaluates the current message for instances of content violations (comprising, without limitation, objectionable keywords, phrases, symbols, image types ) and determines a severity value associated with the content violations, such as described in relation to FIG. 1. Alternatively or additionally, the violation check function may designate content violations based on the message as a whole comprising an objectionable message type (e.g., advertisements/solicitations, spam messages, weather alerts and the like).

At step 214, the violation check function 108 determines if any content violations were found in the message under evaluation. If no violations were found, the content distribution gateway 106 sends the message at step 216 to the relevant message center(s) 114 for distribution to the relevant end user(s) 116. If violations were found, the violation check function 108 reports the content violations to the violation counters 110.

At step 218, the violation counters 110 increment counters, execute algorithms or the like to derive indices of accumulated content violations (in one embodiment, accumulated numbers of content violations and accumulated severity values) associated with the sender, derived from content violations of the present message and previous messages from the sender. The indices of accumulated content violations may be derived from content violations of messages from the sender directed to particular end users, user groups or networks.

In one embodiment, the indices of accumulated content violations are derived from content violations associated with the current message and previous messages directed to particular end users, user groups or networks to which the current message is directed. For example, if the current message is directed to “user 1,” within “user group A” and “network B,” the indices of accumulated content violations are derived from the present message and previous messages from the sender directed to “user 1,” “user group A” or “network B.”

Optionally, content violations associated with the current message may be used to increment counters, execute algorithms or the like to derive indices of accumulated content violations for other selected users, user groups or networks (i.e., other than which the current message was directed). For example, if the current message is directed to “user 1,” within “user group A” and “network B,” the content violations may be used to increment counters associated with “user 2,” “user group B” or “network C.” In such manner, senders can accumulate indices of content violations associated with selected other users, user groups or networks even for messages that are not directed to the selected others.

At step 220, the blocking/filtering function 112 receives from the violation counters, indices of accumulated content violations associated with the sender and compares the indices to one or more blocking criteria. In one embodiment, the blocking criteria corresponds to the end user, user group or network to which the current message is directed. Optionally, the blocking criteria may be applied to selected other users, user groups or networks (for example, in the case that content violations of the present message are used to increment indices of content violations of the selected other users, user groups or networks).

If the blocking criteria is not satisfied, the content distribution gateway 106 sends the message at step 222 to the relevant message center(s) 114 for distribution to the relevant end user(s) 116. At step 224, the content distribution gateway 106 sends a warning to the sender of the message, to inform the sender that content violations were found in the current message. Optionally, the warning may indicate the number of violations and severity number of the present message and/or the accumulated numbers of violations and severity numbers from the present and past messages. In one embodiment, the sender may deregister one or more relevant end users, user groups or networks, at its own option responsive to the warning; but the warning does not require the sender to deregister any end users, user groups or networks.

If the blocking criteria is satisfied, the blocking/filtering function 112 blocks the current message at step 226. At step 228, the content distribution gateway 106 sends a message to the sender instructing the sender to deregister the end user (or user group or network) to which the current message was directed; and at step 230, the content distribution gateway 106 removes the sender from the white list, thereby effectively blocking further messages from the sender to the end user (or user group or network).

In the case that content violations of the present message are applied to selected other users, user groups or networks (i.e., other than which the current message was directed) causing satisfaction of the blocking criteria of the selected other users, user groups or networks, the content distribution gateway 106 may optionally instruct the sender to deregister any of the selected other users, user groups or networks and/or remove the sender from the relevant white lists associated with the selected other users, user groups or networks, thereby effectively blocking further messages from the sender to the selected other users, user groups or networks.

The specific exemplary embodiments of the present invention have been described with some aspects simplified or omitted. Those skilled in the art will appreciate variations from these embodiments that fall within the scope of the invention. For example and without limitation, the violation check function 108, violation counters 110 or blocking/filtering function 112, might be implemented wholly or partially in the message centers 114 or generally may reside in any element or combination of elements at the discretion of the service provider.

The described embodiments are to be considered in all respects only as illustrative and not restrictive. The invention may be deployed in generally any wireline, wireless or IMS network including those with network topologies that differ from FIG. 1. The scope of the invention is, therefore, indicated by the appended claims rather than by the foregoing description. All changes that come within the meaning and range of equivalency of the claims are to be embraced within their scope.

What is claimed is:

1. A method comprising:
receiving one or more electronic messages from a sender;
evaluating the messages for indices of accumulated content violations;
comparing the indices to one or more blocking criteria; and
responsive to the indices of accumulated content violations exceeding the blocking criteria, blocking further messages from the sender.

2. The method of claim 1, further comprising maintaining a database including the one or more blocking criteria.

3. The method of claim 2, wherein the database includes blocking criteria associated with one or more end users.

4. The method of claim 2, wherein the database includes blocking criteria associated with one or more user groups.

5. The method of claim 2, wherein the database includes blocking criteria associated with one or more messaging networks.

6. The method of claim 1, wherein the step of evaluating comprises determining a number of accumulated content violations, and wherein the step of comparing comprises comparing the number to a blocking criteria defining a maximum allowed number of accumulated content violations.

7. The method of claim 1, wherein the step of evaluating comprises determining a severity number associated with accumulated content violations, and wherein the step of comparing comprises comparing the severity number to a blocking criteria defining a maximum allowed severity number associated with the accumulated content violations.

8. A method comprising:
receiving an electronic message from a sender directed to an end user;
evaluating the message for content violations;
responsive to finding one or more content violations, determining indicia of accumulated content violations associated with messages from the sender directed to the end user;
comparing the indicia of accumulated content violations to one or more blocking criteria associated with the end user; and
if the blocking criteria is exceeded, blocking the message from delivery to the end user.

9. The method of claim 8, wherein the step of determining indicia of accumulated content violations comprises determining a number of accumulated content violations.

10. The method of claim 8, wherein the step of determining indicia of accumulated content violations comprises determining a severity number associated with accumulated content violations.

11. The method of claim 8, further comprising, if the blocking criteria is exceeded, instructing the sender to deregister the end user, thereby discontinuing any further messages from the sender directed to the end user.

12. The method of claim 8, further comprising, if the blocking criteria is exceeded, removing the sender from a white list defining a list of senders that are deemed trustworthy.

13. The method of claim 8, further comprising, if the blocking criteria is exceeded, adding the sender to a black list defining a list of senders that are deemed untrustworthy.

14. The method of claim 8, further comprising, if the blocking criteria is not exceeded, delivering the message to the end user.

15. A computer-readable storage medium having embodied thereon executable program code that when executed by a processor implements the steps of the method of claim 8.

16. An apparatus for use in a communication system including a content sender and at least one message center, the at least one message center being configured to deliver messages from the content sender to one or more end users, the apparatus comprising:
a gateway configured for connection between the content sender and the at least one message center;
the gateway comprising a processor coupled to a memory;
wherein the gateway is operable under control of the processor to receive one or more electronic messages from the content sender, evaluate the messages for indicia of accumulated content violations and, responsive to the indicia exceeding a blocking criteria, blocking further messages from the content sender.

17. The apparatus of claim 16, wherein the gateway is operable to determine a number of accumulated content violations, compare the number to a blocking criteria defining a maximum allowed number and, responsive to the number exceeding the blocking criteria, blocking further messages from the content sender.

18. The apparatus of claim 16, wherein the gateway is operable to determine a severity number associated with accumulated content violations, compare the severity number to a blocking criteria defining a maximum allowed severity number and, responsive to the severity number exceeding the blocking criteria, blocking further messages from the content sender.

19. The apparatus of claim 16, wherein the gateway includes a database having indicia of senders that are deemed trustworthy, defining a white list;
wherein the gateway is operable under control of the processor to block messages from content providers not on the white list; and to remove the content providers from the white list if accumulated content violations from the content providers exceed the blocking criteria.

20. The apparatus of claim 16, wherein the gateway includes a database having indicia of senders that are deemed untrustworthy, defining a black list;
wherein the gateway is operable under control of the processor to block messages from content providers on the black list; and to add the content providers to the black list if accumulated content violations from the content providers exceed the blocking criteria.
